(19) United States
(12) Patent Application Publication
(10) Pub. No.: US 2011/0320963 A1
(43) Pub. Date: Dec. 29, 2011

(54) SYSTEMS AND METHODS FOR CONTROLLING MULTIPLE USER ACCESS TO MEDIA DEVICES IN A CONNECTED PLATFORM ENVIRONMENT

(75) Inventor: Ka Chun Wong, Tai Po (HK)

(73) Assignee: ROVI TECHNOLOGIES CORPORATION, Santa Clara, CA (US)

(21) Appl. No.: 12/824,322

(22) Filed: Jun. 28, 2010

(51) Int. Cl. G06F 3/01; G06F 15/16

(52) U.S. Cl. 715/755

(57) ABSTRACT

Systems and methods are presented for utilizing multiple communication channels to determine whether a media device is nearby and whether the nearby media device is a media device associated with a user request. In some embodiments, user input devices may be equipped with IR and RF transceivers. IR signals may be used to determine whether the user input device is in the vicinity of a media device. When a user requests an application or screen sharing of a media device different from the local media device, the user input device may activate the RF transceiver to handle the communications with the other media device. In some embodiments, access to a media device may be prevented for one user when the media device is already providing access to a different user.

### BACKGROUND OF THE INVENTION

This application relates to using user input devices to connect to and switch between media sources in a connected platform environment.

Traditional systems allow a user to connect multiple media sources such as a set-top box, computer, and/or gaming console to a television display. However, to switch between the sources and activate functions at a respective source, users would have to (1) manually change the source designation through an on screen menu, and (2) manually activate the desired function at the respective source.

Furthermore, in connected platform environments, there is the potential that multiple user input devices would be available or in use simultaneously in a single household, and users of the input devices may attempt to simultaneously connect to a particular media source. In such situations, current systems are ineffective in determining which input device should be granted access to the particular media source.

### SUMMARY OF THE INVENTION

In view of the foregoing, it would be desirable to provide systems and methods for identifying media devices using multiple communication channels and providing instructions to the media devices over the appropriate communication channel. In particular, multiple communication channels can be utilized to determine whether a media device is nearby and whether the nearby media device is a media device associated with a user request.

In one aspect, a first signal may be transmitted with a user request on a first communication channel from a user input device. For example, the first signal may be a command associated with a particular application on a media device in a connected platform environment. The first communication channel may have a limited range to ensure that the user input device is in a vicinity of a media device. For example, the first signal may be an IR signal. A media device that receives the first signal may issue a response on the first communication channel. The user input device may receive the response from the responding media device on the first communication channel.

Upon receiving the response from the responding media device, a second communication channel may be established between the user input device and a media device in range of the user input device via the second communications channel. For example, the user input device may establish an RF communication channel with the responding device or another media device within RF range of the user input device. In some embodiments, the second communications channel has a longer range than the first communications channel.

In some embodiments, the user request is associated with a request to access a media asset from a particular media device. In some embodiments, the particular media device may be compared with the responding media device. If the particular media device is not the same as the responding media device, the second communications channel may be established with, for example, the particular media device.

In some embodiments, a second signal may be transmitted via the second communications channel, wherein the second signal includes an instruction for the particular media device to transmit its display information to the responding media device. In some embodiments, the display information is received from the particular media device and the responding media device displays the display information of the particular media device.

In some embodiments, it would be desirable to provide systems and methods for determining which user input device should be given priority in communications with media devices when multiple users attempt to access the same media device for connected platform activities. For example, users may be provided access to media devices based on priority levels of the users in a connected platform environment.

In one aspect, a first user request from a first user input device is received at a first media device. For example, the first user request may be a request for the first media device to activate an application and/or share its screen with a second media device. The first media device may execute the first user request by activating the application and sharing its screen with the second media device. Then, a second user request may be received at the first media device from a second user input device. For example, the second user request may be another request for the first media device to share its screen with a third media device.

In some embodiments, a determination may be made to determine whether the first media device can execute both user requests simultaneously. If the first media device cannot execute both requests simultaneously, a determination is made to determine which user request is associated with a higher priority level. The user request associated with the higher priority level may be executed upon determining which user request is associated with the higher priority level.

In some embodiments, a message is provided to a user associated with a lower priority level that notifies the user that the requested media device is occupied by another user. In some embodiments, the execution of the user request associated with the higher priority level continues substantially uninterrupted after the determination of which user request is associated with the higher priority level. In some embodiments, the execution of the user request associated with the lower priority level is halted after the determination of which user request is associated with the higher priority level.

In some embodiments, an option to monitor the first media device to determine when the device becomes unoccupied may be provided to a user at a user input device associated with the lower priority level. In some embodiments, the first media device may execute both user requests simultaneously upon determining that simultaneous execution is possible.

The media devices and media sources may be any suitable device, for example, at least one of a television, a computer, a wireless device, or a gaming console. The user input devices may include any suitable input device, for example, at least one of a keyboard, a television remote, a set-top box remote, or a gaming controller.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative media device in accordance with an embodiment;

FIG. 2 shows an illustrative user input device in accordance with an embodiment;

FIG. 3 is a diagram of an illustrative cross-platform interactive media system in accordance with an embodiment;

FIG. 4 is a diagram of an illustrative connected platform environment in accordance with an embodiment;

FIG. 5 shows illustrative displays of screen sharing in a connected platform environment in accordance with an embodiment;

FIG. 6 is an illustrative display of a connected platform device configuration screen in accordance with an embodiment;

FIG. 7 is an illustrative process for sharing display information at a remote media device and displaying the shared display information at a local media device in accordance with an embodiment;

FIG. 8 is an illustrative process for determining whether a user input device is within the vicinity of a media device in a connected platform environment using two communication channels in accordance with an embodiment; and

FIG. 9 is an illustrative process for preventing a user from accessing a remote media device that is already occupied by another user in a connected platform environment in accordance with an embodiment.

### DETAILED DESCRIPTION

To provide an overall understanding of the disclosure, certain illustrative embodiments will now be described, including systems and methods for using user input devices in a connected platform environment. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

The term “multimedia,” “media,” or “media asset” is defined herein as content that utilizes content forms, such as text, audio, still images, animation, video, and interactivity content forms. Multimedia content may be recorded and played, displayed or accessed by information content processing devices, such as computerized and electronic devices, but can also be part of a live performance. It should be understood that the embodiments that are discussed in relation to media content are applicable to content, such as video, audio, applications, and/or multimedia, and/or any other suitable type of media and/or content.

In some embodiments, media accessed at any device may be provided to any other suitable device. For example, a first media device may access a video file, audio file, application, or any other suitable asset from a second media device. Herein, this may be referred to as “asset sharing,” “media sharing,” “application sharing,” “media asset sharing,” or simply “sharing.” In some embodiments, sharing may refer to transmitting media asset data from the storage of a first media device to a second media device. In such a situation, the first media device does not process the media asset information for accessing at the first media device; however, the second media device may process and provide the media asset at the second media device as the media asset information is being transferred or thereafter. For example, media accessed at a PC can be provided to a traditional television display for viewing. In some embodiments, sharing may refer to a transfer or copy of the media asset data from the storage of the first media device to the storage of the second media device. Control of the shared media asset may be exerted at either the first or second media devices.

In some embodiments, the second media device may transmit all or a portion of its display information to the first media device for display at the first media device. For example, computer desktop display information of a computer may be duplicated and transmitted from the computer to a television, which may then display the computer desktop information on its own display. Herein, this may be referred to as “screen sharing,” “display sharing,” or “sharing.” In some embodiments, users at the first media device may control the user interface (UI) of the second media device when the two devices are engaged in screen sharing. It should be noted that illustrative embodiments described herein which refer to either asset sharing or screen sharing may be equally applicable to both forms of sharing.

Herein, the term “connected platform” or “connected platform environment” may refer to any network or networks that includes media devices and/or input devices that may provide and/or execute asset or screen sharing instructions.

In some embodiments, guidance applications (e.g., an interface that allows users to efficiently navigate media selections) allow users to navigate among multiple remote and local media equipment. For example, the guidance applications may allow users to navigate between a set-top box, personal computer, and gaming console that may be located within a single household. In some embodiments, one or more of the media equipment may be located remotely, such as, at a centralized distribution center or another household. Herein, the term “household” may refer to any commercial or noncommercial dwelling or place of business.

Herein, the terms “media source,” “media equipment device,” “media device,” or “media equipment” may refer to any suitable device that may access and/or provide media. This may include, for example, cable provider distribution facilities, televisions, gaming consoles, mobile devices, set-top boxes, or any other suitable device capable of viewing and/or providing media.

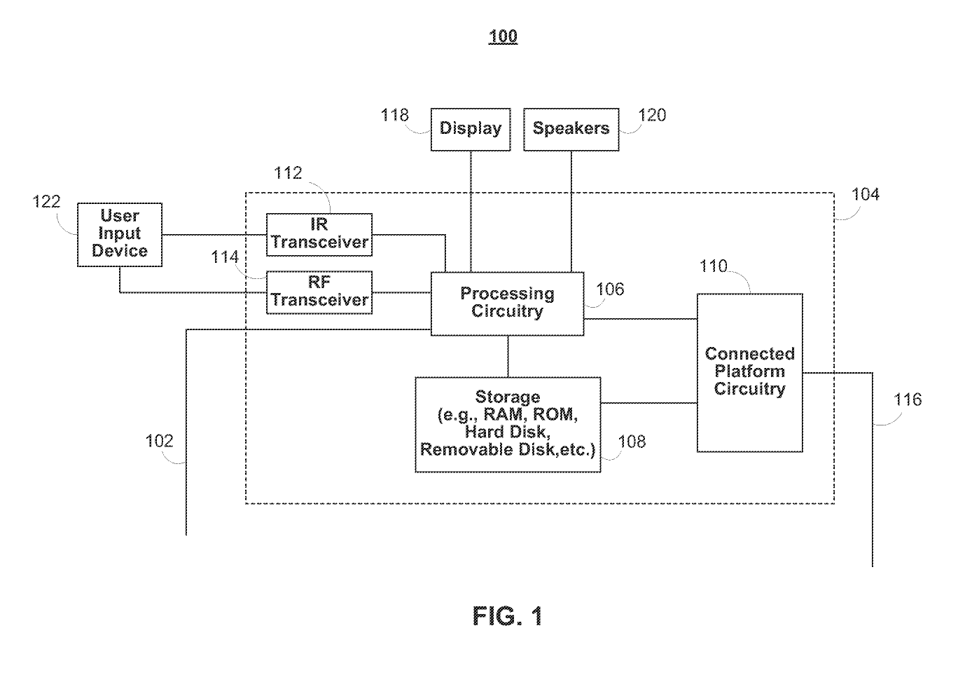

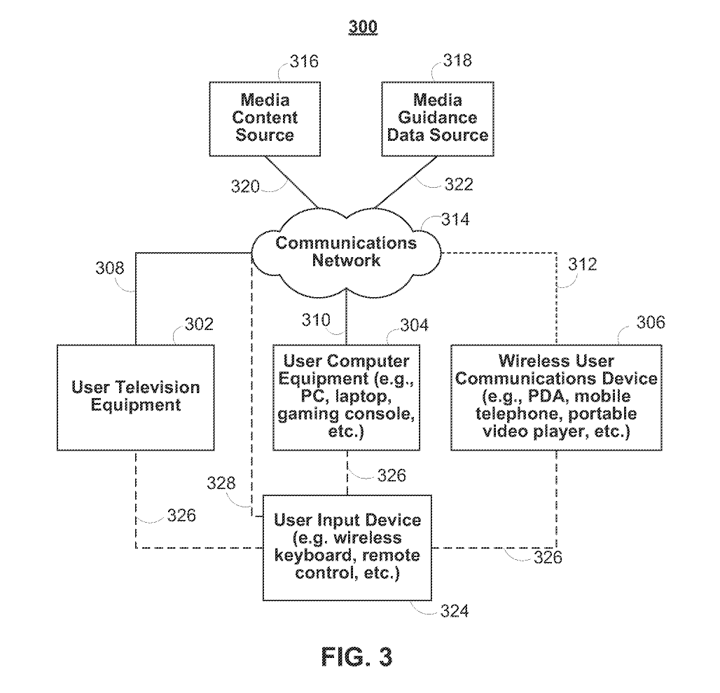

FIG. 1 shows a generalized embodiment of illustrative media equipment device 100. More specific implementations of media equipment devices are discussed below in a connection with FIG. 3. Media device 100 may receive media content and data via input/output (hereinafter “I/O”) path 102. I/O path 102 may provide media content (e.g., broadcast programming, on-demand programming, Internet content, content from other media equipment devices, and other video or audio) and data to control circuitry 104, which may include processing circuitry 106, storage 108, connected platform circuitry 110, IR transceiver 112, and RF transceiver 114.

Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1 to avoid overcomplicating the drawing.

Control circuitry 104 may be based on any suitable processing circuitry 106 such as processing circuitry based on one or more microprocessors, microcontrollers, digital signal processors, programmable logic devices, etc. In some embodiments, control circuitry 104 executes instructions for a media guidance application stored in memory (i.e., storage 108). In client-server based embodiments, control circuitry 104 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 3). In addition, communications circuitry may include circuitry that enables peer-to-peer communication of media devices, or communication of media devices in locations remote from each other (described in more detail below).

In some embodiments, control circuitry 104 may include connected platform circuitry 110 which may be capable of providing information about and communicating with media devices remote to media device 100. Connected platform circuitry 110 may be further capable of handling user input device communications that are intended for media devices remote to media device 100. In some embodiments, connected platform circuitry 110 may communicate with user input devices and/or media devices directly (e.g., bypassing control circuitry 104) via I/O path 116, which may be substantially similar to I/O path 102. In some embodiments, connected platform circuitry 110 is integrated into media device 100 (e.g., integrated into control circuitry 104), for example, using AMIMON's AMN 2120/2200 integrated circuits. In some embodiments, connected platform circuitry 110 is connected to media device 100 through any suitable means, for example, via USB cable, coaxial cable, Ethernet cable, or any other suitable wired or wireless means. In such an embodiment, connected platform circuitry 110 may reside in an external device, such as, D-Link's PC-on-TV Media Player DPG-1200 or an Intel Wireless Display device.

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 108 that is part of control circuitry 104. Storage 108 may include one or more of the above types of storage devices. For example, media device 100 may include a hard drive for a DVR (sometimes called a personal video recorder, or PVR) and a DVD recorder as a secondary storage device. Storage 108 may be used to store various types of media described herein and guidance application data, including program information, guidance application settings, user preferences or profile information, a list of active users at a media device, a list of past users at a media device, or other data used in operating the guidance application. Nonvolatile memory may also be used (e.g., to launch a boot-up routine and other instructions).

Control circuitry 104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 104 may also include scaler circuitry for upconverting and downconverting media into the preferred output format of media device 100. Circuitry 104 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 108 is provided as a separate device from media device 100, the tuning and encoding circuitry (including multiple tuners) may be associated with storage 108.

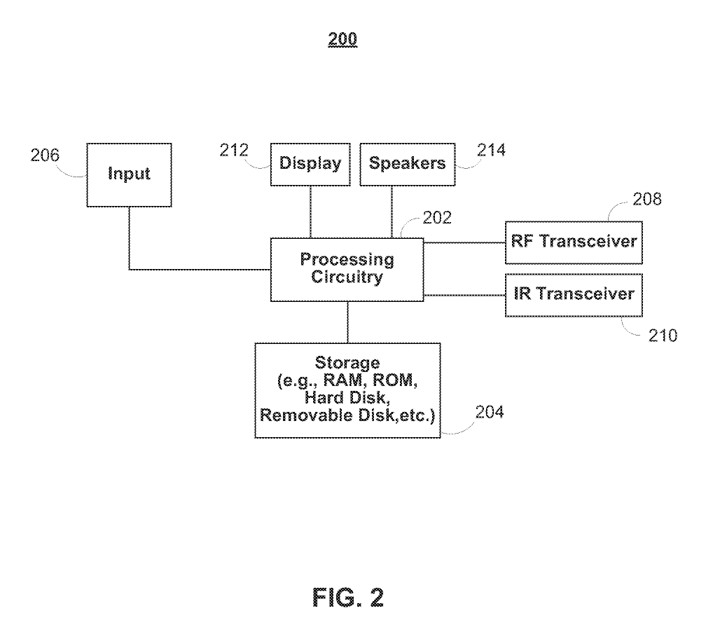

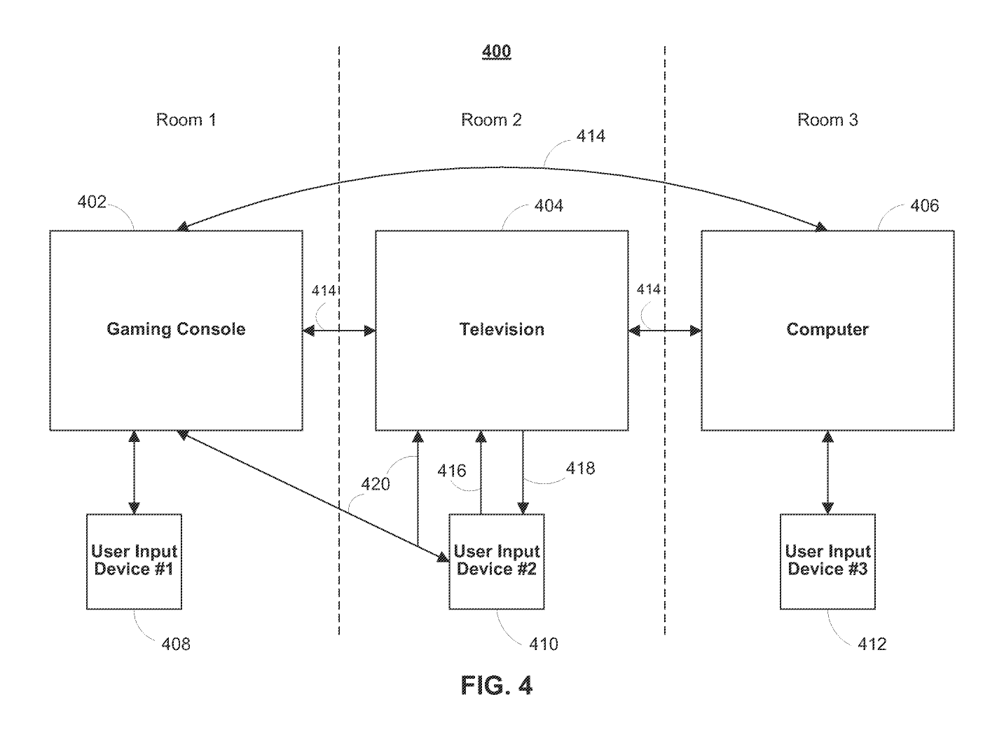

A user may control the control circuitry 104 using user input device 122, which is described in greater detail below with regard to FIG. 2. User input device 122 may communicate with media device 100 using any suitable wired and/or wireless means. As an illustrative example, control circuitry 104 is depicted including infrared (IR) transceiver 112 and radio-frequency (RF) transceiver 114 to communicate with user input device 122. One of ordinary kill would recognize that transceivers 112 and 114 may be any suitable circuitry capable of communicating with user input device 122. In some embodiments, one or both of transceivers 112 and 114 may be combined or removed. In some embodiments, one or both of transceivers 112 and 114 may be capable of communicating with user input device 122 using any other suitable means instead of or in addition to IR and RF, for example, optical, any other suitable wireless, or any other wired means. In some embodiments, media device 100 may utilize communication with user input device 122 over one or both of transceivers 112 and 114 to determine whether a user is located near media device 100 and/or determine whether the user is active at media device 100. Such embodiments are described in further detail below with regard to FIGS. 4-9. Further systems and methods for detecting and/or identifying users at media equipment are discussed in greater detail in connection with Shimy et al., U.S. patent application Ser. No. 12/565,495 (Attorney Docket No. UV-495A), filed Sep. 23, 2009, which is hereby incorporated by reference herein in its entirety.

Display 118 may be provided as a stand-alone device or integrated with other elements of media device 100. Display 118 may be one or more of a monitor, a television, a liquid crystal display (LCD) for a mobile device, or any other suitable equipment for displaying visual images. In some embodiments, display 118 may be HDTV-capable. Speakers 120 may be provided as integrated with other elements of media device 100 or may be stand-alone units. The audio component of videos and other media content displayed on display 118 may be played through speakers 120. In some embodiments, the audio may be distributed to a receiver (not shown), which processes and outputs the audio via speakers 120.

The guidance application may be implemented using any suitable architecture. For example, it may be a stand-alone application wholly implemented on media device 100. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on media device 100 is retrieved on-demand by issuing requests to a server remote to the media device 100. In one example of a client-server based guidance application, control circuitry 104 runs a web browser that interprets web pages provided by a remote server.

In yet other embodiments, the media guidance application is downloaded and interpreted or otherwise run by an interpreter or virtual machine (run by control circuitry 104). In some embodiments, the guidance application may be encoded in the ETV Binary Interchange Format (EBIF), received by control circuitry 104 as part of a suitable feed, and interpreted by a user agent running on control circuitry 104. For example, the guidance application may be an EBIF widget. In other embodiments, the guidance application may be defined by a series of JAVA-based files that are received and run by a local virtual machine or other suitable middleware executed by control circuitry 104. In some of such embodiments (e.g., those employing MPEG-2 or other digital media encoding schemes), the guidance application may be, for example, encoded and transmitted in an MPEG-2 object carousel with the MPEG audio and video packets of a program.

FIG. 2 shows a generalized embodiment of illustrative user input device 200, which is substantially similar to user input device 122 of FIG. 1. User input device 200 may include processing circuitry 202, storage 204, input 206, RF transceiver 208, IR transceiver 210, display 212, and speakers 214. Processing circuitry 202, storage 204, display 212, and speakers 214 may be substantially similar to processing circuitry 106, storage 108, display 118, and speakers 120 of FIG. 1, respectively. User input device 200 may communicate with one or more media device.

Input 206 may include any suitable user interface, such as a remote control, mouse, trackball, keypad, keyboard, touch screen, touch pad, stylus input, joystick, voice recognition interface, or other user input interfaces, or combination of user input interfaces. In some embodiments, input 206 may include pressure-sensitive buttons. Processing circuitry 202 may recognize different amounts of pressure applied to the pressure-sensitive buttons and adjust navigation through, for example, the guidance application. For example, the amount of pressure applied may adjust the speed of scrolling through guidance application listings, such that when less pressure is applied, the listings scroll slower and when more pressure is applied, the listings scroll faster. The pressure-sensitive buttons may control any portion of the guidance application or a media device in any suitable manner.

In some embodiments, user input device 200 may be incorporated into a mobile device, such as a mobile phone. In such embodiments, user input device 200 may obtain appropriate commands, information, and/or updates associated with a user or media device, or any other suitable information via the cellular phone network.

In some embodiments, user input device 200 may communicate with media devices using any suitable means, for example, radio-frequency identification, Bluetooth, Wi-Fi, WiMax, internet protocol, infrared signals, any other suitable IEEE, industrial, or proprietary communication standards, or any other suitable electronic optical, or auditory communication means. For example, user input device 200 include RF transceiver 208 and IR transceiver 210 to communicate with media devices, such as, media device 100 of FIG. 1. Additionally, or alternatively, user input device 200 may communicate with media device 100 using wired means, for example, using USB connection. In such embodiments, RF transceiver 208 and/or IR transceiver 210 may be modified accordingly to enable such communication. In some embodiments, user input device 200 may communicate with an intermediate device that may convert any suitable communication means to any other suitable communication means. For example, a user may attempt to scroll through a guidance application using the user's mobile phone incorporated with user input device 200. User input device 200 may output Wi-Fi packets using RF transceiver 208 to communicate with user's scroll instructions. An intermediate device may receive the Wi-Fi packets and in turn transmit infrared packets to control circuitry 104 of FIG. 1.

In some embodiments, user input device may be mobile, for example, a wireless keyboard. As such, users may move between multiple media devices with the same user input device. Furthermore, there may be more than one user input device in a single household, as such, wireless communications originating from multiple user input devices may be received by one or more media devices. Systems and methods for handling such situations are described below with regard to FIGS. 4-9.

In some embodiments, RF transceiver 208 and IR transceiver 210 may be used to communicate with IR transceiver 112 and RF transceiver 114 of media device 100 of FIG. 1 to determine whether the user is local to the media equipment device (e.g., as opposed to receiving a stray signal intended for a different media device). Such embodiments are discussed in further detail below with regard to FIGS. 4-9.

Media device 100 of FIG. 1 may be implemented in system 300 of FIG. 3 as user television equipment 302, user computer equipment 304, or wireless user communications device 306, or any other suitable type of user equipment suitable for accessing media. User input device 200 of FIG. 2 may be implemented in system 300 of FIG. 3 as user input device 324 or any other suitable type of user input device suitable for providing user inputs to a media device. For simplicity, television equipment 302, user computer equipment 304, wireless user communications device 306 may be referred to herein collectively as user equipment, user equipment devices, or media devices. Media devices may function as a standalone device or may be part of a network of devices. Various network configurations of devices may be implemented and are discussed in more detail below.

User television equipment 302 may include a set-top box, an integrated receiver decoder (IRD) for handling satellite television, a television set, a digital storage device, a DVD recorder, a video-cassette recorder (VCR), a local media server, a connected platform circuitry such as connected platform circuitry 110 of FIG. 1, or other user television equipment. One or more of these devices may be integrated to be a single device, if desired. User computer equipment 304 may include a PC, a laptop, a tablet, a WebTV box, a personal computer television (PC/TV), a PC media server, a PC media center, a gaming machine, or other user computer equipment. WEBTV is a trademark owned by Microsoft Corp. Wireless user communications device 306 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 302, user computer equipment 304, and wireless user communications device 306 may utilize at least some of the system features described above in connection with FIG. 1 and, as a result, include flexibility with respect to the type of media content available on the device. For example, user television equipment 302 may be Internet-enabled allowing for access to Internet content, while user computer equipment 304 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

Each of user television equipment 302, user computer equipment 304, and wireless user communications device 306 may be integrated with and/or be in communication with user input device 324. User input device 324 may be substantially similar to the user input device 200 of FIG. 2. User input device 324 may include one or more user input devices. In some embodiments, user input devices may communicate with one or more of user television equipment 302, user computer equipment 304, and wireless user communications device 306 directly (e.g., physically connected or wirelessly paired) via paths 326 or by using communications network 314 (e.g., using the Internet) via path 328. Paths 326 and 328 are drawn with dotted lines to indicate that the paths may be temporary because user input device 324 may move between media devices, and as such, may reestablish connections accordingly. Communication to and from user input device 324 along paths 326 and/or 328 may be completed by, for example, RF transceiver 208 and IR transceiver 210 of FIG. 2, or any suitable variation thereof.

In system 300, there is typically more than one of each type of media device but only one of each is shown in FIG. 3 to avoid overcomplicating the drawing. In addition, each user may utilize more than one type of user equipment device (e.g., a user may have a television set and a computer) and also more than one of each type of media device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, multiple-user use and access configuration options, connected platform settings, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device may change the guidance experience on another media device, regardless of whether they are the same or a different type of media device. In addition, the changes made may be based on settings input by a user or system operator, as well as user activity monitored by the guidance application.

The media devices may be coupled to communications network 314. Namely, user television equipment 302, user computer equipment 304, and wireless user communications device 306 are coupled to communications network 314 via communications paths 308, 310, and 312, respectively. Communications network 314 may be one or more networks including the Internet, a mobile phone network, mobile device (e.g., Blackberry) network, cable network, public switched telephone network, local area network, or other types of suitable communications networks or suitable combinations of communications networks. BLACKBERRY is a service mark owned by Research In Motion Limited Corp. User television equipment 302, user computer equipment 304, and/or wireless user communications device 306 may communicate via communications paths using, for example, RF transceiver 114 and IR transceiver 112 of FIG. 1. In some embodiments, media devices may share media or share displays using a connectivity standard, such as wireless home digital interface (WHDI), digital living network alliance (DLNA), wirelessHD, or any other suitable connectivity standard.

Paths 308, 310, and 312 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 312 is drawn as a dotted line to indicate that in the exemplary embodiment shown in FIG. 3 it is a wireless path and paths 308 and 310 are drawn as solid lines to indicate they are wired paths (although these paths may be wired and/or wireless paths, if desired). Communications with the user equipment devices may be provided by one or more of these communications paths, but are shown as a single path in FIG. 2 to avoid overcomplicating the drawing.

Although communications paths are not drawn between media devices or between user input devices, these devices may communicate directly with each other via communication paths, such as those described above in connection with paths 308, 310, 312, 326, and 328, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices and user input devices may also communicate with each other directly through an indirect path via communications network 314.

System 300 includes media content source 316 and media guidance data source 318 coupled to communications network 314 via communication paths 320 and 322, respectively. Paths 320 and 322 may include any of the communication paths described above in connection with paths 308, 310, 312, 326, and 328. Communications with the media content source 316 and media guidance data source 318 may be exchanged over one or more communications paths, but are shown as a single path in FIG. 3 to avoid overcomplicating the drawing. In addition, there may be more than one of each of media content source 316 and media guidance data source 318, but only one of each is shown in FIG. 3 to avoid overcomplicating the drawing. (The different types of each of these sources are discussed below.) If desired, media content source 316 and media guidance data source 318 may be integrated as one source device. Although communications between sources 316 and 318 with media devices 302, 304, and 306 and user input device 324 are shown as through communications network 314, in some embodiments, sources 316 and 318 may communicate directly with media devices 302, 304, and 306 or user input device 324 via communication paths (not shown) such as those described above in connection with paths 308, 310, 312, 326, and 328.

Media content source 316 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 316 may be the originator of media content (e.g., a television broadcaster, a Webcast provider, etc.) or may not be the originator of media content (e.g., an on-demand media content provider, an Internet provider of video content of broadcast programs for downloading, etc.). Media content source 216 may include cable sources, satellite providers, on-demand providers, Internet providers, or other providers of media content. Media content source 316 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244 (Attorney Docket No. UV-84), filed Jun. 11, 1999, which is hereby incorporated by reference herein in its entirety.

Media guidance data source 318 may provide media guidance data, such as media listings, media-related information (e.g., broadcast times, broadcast channels, media titles, media descriptions), ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the media devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to media devices on a television channel sideband, in the vertical blanking interval of a television channel, using an in-band digital signal, using an out-of-band digital signal, or by any other suitable data transmission technique. Program schedule data and other guidance data may be provided to media devices on multiple analog or digital television channels. Program schedule data and other guidance data may be provided to the media devices with any suitable frequency (e.g., continuously, daily, a user-specified period of time, a system-specified period of time, in response to a request from media devices, etc.). In some approaches, guidance data from media guidance data source 318 may be provided to users' media devices using a client-server approach. For example, a guidance application client residing on the user's media device may initiate sessions with source 318 to obtain guidance data when needed. Media guidance data source 318 may provide media devices 302, 304, and 306 the media guidance application itself or software updates for the media guidance application.

Media guidance applications may be, for example, stand-alone applications implemented on media devices. In other embodiments, media guidance applications may be client-server applications where only the client resides on the media device. For example, media guidance applications may be implemented partially as a client application on control circuitry 104 of media device 100 and partially on a remote server as a server application (e.g., media guidance data source 318). The guidance application displays may be generated by the media guidance data source 318 and transmitted to the media devices. The media guidance data source 318 may also transmit data for storage on the media device, which then generates the guidance application displays based on instructions processed by control circuitry.

Media guidance system 300 is intended to illustrate a number of approaches, or network configurations, by which media devices and sources of media content and guidance data may communicate with each other for the purpose of accessing or sharing media and providing media guidance. The present invention may be applied in any one or a subset of these approaches, or in a system employing other approaches for delivering media and providing media guidance. The following three approaches provide specific illustrations of the generalized example of FIG. 3.

In one approach, media devices may communicate with each other within a home network. Media devices can communicate with each other directly via short-range point-to-point communication schemes describe above, via indirect paths through a hub or other similar device provided on a home network, via connected platform circuitry such as connected platform circuitry 110 of FIG. 1, via communications network 314, or some combination thereof. Each of the multiple individuals in a single home may operate different media devices on the home network. As a result, it may be desirable for various media guidance information or settings to be communicated between the different media devices. For example, it may be desirable for users to maintain consistent media guidance application settings on different media devices within a home network, as described in greater detail in Ellis et al., U.S. Patent Application Publication No. 2005-0251827, published Nov. 10, 2005. Different types of media devices in a home network may also communicate with each other to transmit media content. For example, a user may transmit media content from user computer equipment to a portable video player or portable music player. In some embodiments, media devices may communicate with one another for screen sharing purposes. This may allow a user, for example, to view a computer's desktop from their television.

In a second approach, users may have multiple types of media devices by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, connected platform settings or other settings) on the online guidance application to control the user's in-home equipment. The online guide may control the user's media devices directly, or by communicating with a media guidance application on the user's in-home media devices. Various systems and methods for media devices communicating, where the media devices are in locations remote from each other, is discussed in, for example, Ellis et al., U.S. Patent Application Publication No. 2005-0028208, published Feb. 3, 2005, which is hereby incorporated by reference herein in its entirety.

In a third approach, users of media devices inside and outside a home can use their media guidance application to communicate directly with media content source 216 to access media content. Specifically, within a home, users of user television equipment 304 and wireless user communications device 306 may access the media guidance application to navigate among and locate desirable media content. For example, a user may access pictures that are stored on a computer from the user's television. In some embodiments, the user may also share screens between the devices, for example, displaying the computer's desktop on the television. Users may also access the media guidance application outside of the home using wireless user communications devices 206 to navigate among and locate desirable media content.

It will be appreciated that while the discussion of media content has focused on video content, the principles of media guidance can be applied to other types of media content, such as music, images, etc.

FIG. 4 shows illustrative connected platform environment 400 wherein devices in a single household may communicate with one another to share media, functions, applications, and/or screens. Connected platform environment 400 includes gaming console 402, television 404, computer 406, first user input device 408, second user input device 410, and third user input device 412. Gaming console 402 and computer 406 may be substantially similar to user computer equipment 304 of FIG. 3. Television 404 may be similar to user television equipment 302 of FIG. 3. First user input device 408, second user input device 410, and third user input device 412 may be substantially similar to user input device 324 of FIG. 3.

The media devices of connected platform environment 400 may be positioned in separate rooms in the household. For example, gaming console 402 may be placed in room 1, television 404 may be placed in room 2, and computer 406 may be placed in room 3. In the connected platform environment, the media devices can share media and/or displays between one another using, for example, communications network 314 of FIG. 3, even when placed in different locations. For example, a user in room 2 may be able to view the desktop of computer 406 on television 404 and control computer 406 using a user input device located in room 2. Likewise, the user may view the display of gaming console 402 on television 404 and control console 402 using a user input device in room 2. Conversely, a user in room 1 may be able to view media displayed on television 404 using gaming console 402 and control television 404 using a user input device in room 1. As shown by paths 414, media and display sharing may occur between any devices in environment 400 in any suitable manner. For example, gaming console 402 may share its display with computer 406 directly, or communications between console 402 and computer 406 may be exchanged via television 404. In some embodiments, display sharing and remote control of the media devices may be enabled by connected platform circuitry, such as connected platform circuitry 110 of FIG. 1. The connected platform circuitry may be embedded in one or more of the media devices and/or may be connected to the media devices through an external device (e.g., D-Link's PC-on-TV Media Player DPG-1200).

User input devices 408, 410, and 412 may communicate with any of the media devices in environment 400 through wired and/or wireless connections. In some embodiments, user input devices 408, 410, and 412 may be mobile, for example, a user in room 2 may take second user input device 410 into room 1. In some embodiments, media devices and/or user input devices may detect the location change and adjust their communications accordingly. For example, second user input device 410 may communicate with television 404 when both are located in room 2. When second user input device 410 is relocated to room 1, gaming console 402 and/or user input device 410 may detect the location change. Upon detecting the location change, second user input device 410 may begin communicating with gaming console 402 instead of television 404.

In some embodiments, the location of user input devices may be detected using a two different communication channels. For example, as described earlier with regard to user input device 200 of FIG. 2, user input devices may be equipped with an IR transceiver and an RF transceiver, such as IR transceiver 210 and RF transceiver 208, respectively. IR communications generally require line-of-sight to facilitate data exchange. Therefore, media devices may determine that a user input device is in the vicinity of the respective media device when an IR communication is successfully transmitted to and/or received from a user input device. Conversely, media devices may determine that a user input device is not in the vicinity of a media device when an IR signal is not successfully communicated to a user input device. In some embodiments, the user input device itself may determine whether it is in the vicinity of a particular media device based on IR communications in the same manner. For example, the user input device may determine that any user requests received by the user input device are intended to be displayed using the particular media device that is in the vicinity.

As an illustrative example, a user in room 2 may use second user input device 410 with the intention of controlling gaming console 402 and viewing the display of gaming console 402 on television 404. For example, a user in room 2 may want to activate a game on gaming console 402 and play the game at television 404. Upon pressing an input on device 410, device 410 may transmit IR signal 416 with information regarding the user input and identification of device 410. The identification may be any suitable form of identification, such as a MAC address, IP address, serial number, or any other suitable identification code.

If television 404 successfully receives IR signal 416, television 404 may determine that device 410 is in the vicinity of television 404, and hence, the user of device 410 may want to communicate with television 404. Upon receiving the IR signal, television 404 may transmit IR signal 418 indicating, for example, that input device 410 is unknown to television 404. The IR signal transmitted by television 404 may alternatively, or additionally, indicate that IR signal 416 transmitted by device 410 was successfully received. For example, IR signal 418 transmitted by television 404 may be a type of acknowledgement (ACK) message. In some embodiments, IR signal 418 may include notification that television 404 was previously unaware of input device 410, such as an “unrecognized device” code. IR signal 418 transmitted by television 404 may include any other suitable information, for example, IR signal 418 may include identification of television 404. The identification may be any suitable form of identification, such as, a MAC address, IP address, serial number, or any other suitable identification code.

If television 404 does not receive IR signal 416 transmitted by input device 410, input device 410 may determine that it is not within the vicinity of television 404. For example, device 410 may wait for a predetermined period for a response from a media device. If no response is received within the predetermined period, device 410 may determine that no media device is within range. In response, device 410 may provide some indication to the user of device 410 that it is not within range of any media device. For example, device 410 may provide text stating “no device within range” on a display, such as display 212 of FIG. 2. As another example, device 410 may vibrate to indicate an unsuccessful transmission. Any other suitable indication may be utilized.

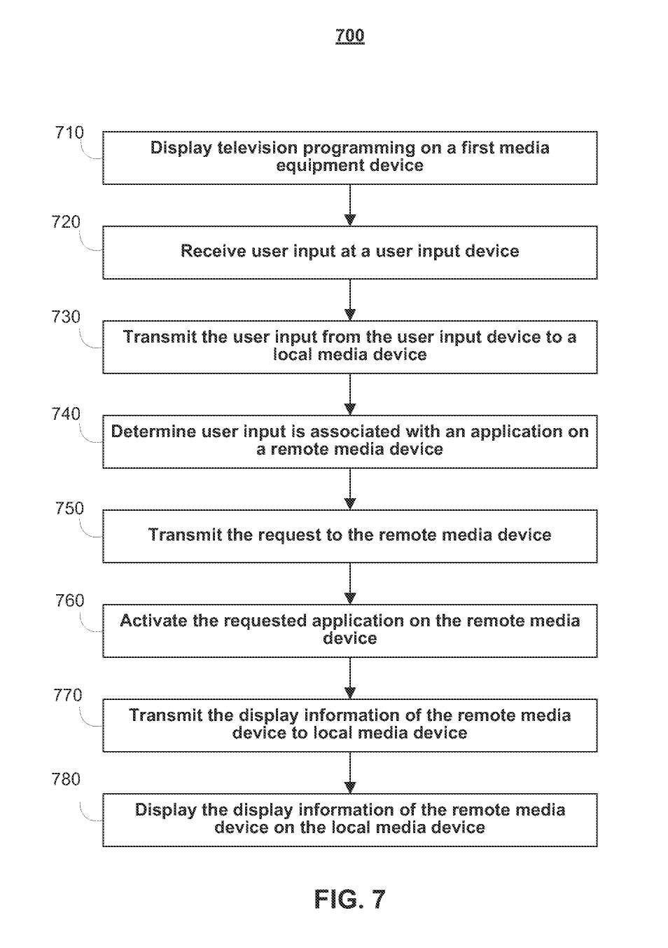

Upon successfully receiving IR signal 418 from television 404, input device 410 may determine that it is within the vicinity of television 404. The successful receipt of IR signal 416 may also allow input device 410 to determine that it is not within the vicinity of other media devices in connected platform environment 400. Upon this determination, input device 410 may activate an RF transmitter, such as RF transceiver 208 of FIG. 2. For example, the user request that initiated the transmission of IR signal 416 may indicate that the user would like to activate a function or application on gaming console 402 and/or initiate screen sharing of console 402. The configuration of connected platform devices is discussed in greater detail below with regard to FIG. 7. Input device 410 may compare the device ID of television 404 received from IR signal 418 with the device ID of the device associated with the user's request. If the two IDs are not the same, input device 410 may determine that it is not in the vicinity of the intended media device. Therefore, input device 410 may use RF communications in order to attempt to communicate with the intended media device.

After activating the RF transmitter, input device 410 may transmit RF signal 420. RF signal may be any suitable form of RF transmission, such as, Wi-Fi or any other suitable RF based communication as described above with regard to FIG. 3. Although RF signal 420 is only shown as being directed to gaming console 402 and television 404, in practice, RF signal 420 may be received by other media devices and user input devices. RF signal 420 may include information identifying television 404 as being the media device that is in the vicinity of the user and gaming console 402 as being the media device that the user intends to control. RF signal 420 may also include information that indicates a user's input into input device 410, for example, a request to activate a game on gaming console 402. RF signal 420 may also include any suitable flags that indicate, for example, that a sharing activity is being requested. RF signal 420 may also include any suitable information associated with a requested media asset, for example, name of the asset, length of the asset (e.g., how long a request video is), and/or storages location(s) of the asset.

When RF signal 420 is received by gaming console 402, console 402 may determine RF signal 420 is a request to share its display with television 404 based on, for example, the identification of the two devices in signal 420. Additionally, console 402 may activate the requested function or application that may have been included in signal 420. For example, console 402 may activate the game requested by the user.

Once gaming console 402 determines it is to share its display with television 404, gaming console 402 will begin transmitting information about its display to television 404. This transmission may be completed using any suitable communication means, such as those described with regard to FIG. 3. When television 404 receives the display information from console 402, television 404 may automatically change a channel to a suitable channel to display the display information of console 402. For example, television 404 may automatically change to a dedicated connected platform channel. As another example, television 404 may be connected to connected platform circuitry through a suitable HDMI cable and connected to a set-top box through a DVI cable. As such, when television 404 receives the display information from gaming console 402, television 404 may automatically switch its source from the DVI input to the HDMI input, thus displaying the display information from gaming console 402 on television 404. Alternatively, or additionally, television 404 may automatically change to the appropriate connected platform channel or source when television 404 receives RF signal 420 from input device 410 that indicates that the user at device 410 would like to view the display of console 402 on television 404. In one embodiment, the display information may be included in a picture-in-picture (PIP) display.

The user may request to return to watching a television program on television 404 after the user has completed playing the game from gaming console 402 that is displayed on television 404. Upon receiving the request, input device 410 may transmit a signal, IR or RF, to television 404 with the request. Television 404 may determine that the request is a request to halt screen sharing with gaming console 402. Upon this determination, television 404 may automatically switch to the appropriate channel or source. For example, television 404 may switch from the dedicated connected platform channel to a normal broadcast channel. As another example, television 404 may switch its source from the input connected to the connected platform circuitry to the input connected to a set-top box.

Although the above example utilizes a combination of IR and RF, any suitable communication means may be utilized. For example, input device 410 may determine that it is in the vicinity of television 404 based RF methods (i.e., without the use of IR), such as a received signal strength indication (RSSI). The devices of connected platform environment may determine their location and/or distance from other devices based on any other suitable method, such as those described in Shimy et al., U.S. patent application Ser. No. 12/565,495 (Attorney Docket No. UV-495A), which has been incorporated by reference above. Additionally, any suitable communication standard may be utilized in place of, or in addition to, the IR and/or RF signals as described with regard to communications network 314 of FIG. 3. In some embodiments, the IR and/or RF signals may take the form of communication packets, wherein they may include all necessary headers and/or data to be successfully communicated in the appropriate standard and executed upon in the connected platform environment.

Although the above example describes gaming console 402 and input device 410 being in direct RF communication, the communications between the two devices may be indirect. For example, the communications may be routed through television 404, any other suitable device, or passed through communications network 314 of FIG. 3 as described above. For example, television 404 may receive an IR signal from input device 410 requesting activation of an application on computer 406 and screen sharing of computer 406 at television 404. Television 404 may relay the request to computer 406 using a local area network. Computer 406 may in turn provide its display information to television 404 using the local area network.

In some embodiments, one user may request media or screen sharing from a media device that is already occupied with a different user. For example, a user using first user input device 408 in room 1 may be occupying gaming console 402. Simultaneously, a user using second user input device 410 in room 2 may request screen sharing of console 402. In such situations, the occupation and/or user conflict of console 402 may be resolved.

When a user requests the use of a media device already occupied with a different user, the media device may respond to the request with information that indicates the media device is currently occupied. The response may include information regarding what processes are currently active on the media device, which user is accessing the media device, how long the user has been active at the media device, and/or any other suitable information. In some embodiments, the information may include information regarding the lengths of currently accessed media assets at the media device. For example, the media device may inform the requesting user that the occupying user is watching a movie that has seven minutes remaining. The requesting user may wish to try to gain access to the media device after the passage of seven minutes.

In some embodiments, a media device local to the requesting user may automatically detect when the requested media device becomes available. For example, it may be detected when the occupying user of the requested device leaves the vicinity of the requested device and/or no longer is active at the requested device. For example, if the occupying user has not provided a new input to the requested device for some period of time, the occupying user may be determined to be inactive. As another example, the occupying user may be determined to be active at the request device for at least the duration of a media asset (e.g., a movie) being accessed by the occupying user. In such situations, the requesting user may be informed that the requested device is now free and/or a media device local to the requesting user may automatically initiate the requested sharing operation when the requested device becomes free. Additional methods for determining whether a user is active at a device are described in Shimy et al., U.S. patent application Ser. No. 12/565,495 (Attorney Docket No. UV-495A), which has been incorporated by reference above.

In some embodiments, the media device may determine which of the users requesting access to a particular media device has priority to access the device. For example, one user may have a higher priority than the other and, as such, provide access of the media device to the higher priority user and halt or prevent access of the media device to the lower priority user. Priority levels may be set using any suitable means. For example, priority levels may be set based on user accounts or profile settings.

In some embodiments, users that are within the vicinity of a particular media device may be given a higher priority than users that are remote to the media device. For example, a user in room 2 may request screen sharing of computer 406 for display on television 404; however, computer 406 may currently be occupied by a user in room 3. In such a situation, the user in room 2 may be denied access to computer 406. For example, a message may be displayed on television 404 that indicates that computer 406 is currently occupied. In some embodiments, the message may be overlaid with any media that is currently being displayed at television 404. In some embodiments, computer 406 may still share media and/or its screen with television 404 without giving the user in room 2 the ability to control, activate, and/or change anything on computer 406. For example, television 404 may display whatever media is being viewed by the user in room 3, but deny the user in room 2 the ability to pause or change the media.

In some embodiments, remote users may be given a higher priority than local users. For example, a user within the vicinity of computer 406 may be occupying computer 406. A user within the vicinity of television 404 may request to activate an application on computer 406 and share its display to television 404. If the user at television 404 has a higher priority than the user at computer 406, access for the user at computer 406 may be halted. For example, a message window may be displayed to the user at computer 406 that another user is now occupying computer 406. In some embodiments, the message window is locally overlaid on the display of computer 406 such that the display of the window is not shared with the user at television 404. In some embodiments, the display of computer 406 may be completely obscured to the user whose access was halted. In some embodiments, the user whose access was halted may still view the display of computer 406 while another user is occupying it. For example, the user local to computer 406 may be able to view the actions of the user remote to computer 406 when the remote user is occupying computer 406 and the local user's access is prevent to computer 406.

In some embodiments, a first remote user may request access to a media device while a second remote user already occupies the same media device. For example, a user in room 1 may be accessing media on gaming console 402 from television 404. Thereafter, a user in room 3 may request access to a different media asset from television 404 for display on computer 406. In such a situation, the user who is currently occupying television 404 (i.e., the user in room 1) may be given a higher priority. Alternatively, the user who later requested access to the occupied media device (i.e., the user in room 3) may be given a higher priority. In some embodiments, the priority is based on other factors such as user profiles and/or settings, or may be decided based on a random, pseudo-random, or weighted decision.

In some embodiments, both users requesting access to the same media device may be given access. For example, multiple media assets may be provided by a single media device to multiple remote users simultaneously without affecting a user occupying the media device. For example, a user may be in room 1 using gaming console 402 to occupy computer 406 to, for example, view computer 406's desktop. Thereafter, a user in room 2 may request to view a video, which is stored in gaming console 402, at television 404. The video may be shared with television 404 without affecting the occupation of computer 406.

Herein, the terms “command” and “request” may equally refer to user instructions that instruct user input devices and/or media devices to perform a particular action. In some embodiments, the user commands and requests discussed herein may be for specific media devices. For example, a request may be computer 406 specific. In such embodiments, the request sent from a user input device may be configured to include a suitable identifier for computer 406. In some embodiments, the request is only device type specific; for example, any computer in the connected platform environment may satisfy the request. In such embodiments, connected platform circuitry, such as circuitry 110 of FIG. 1, may search the environment for a media device of the required device type that is not occupied. For example, there may be two computers in the connected platform environment. When the request is typed into an input device, connect platform circuitry may request a status update from all the known computers in the connected platform environment. If one is occupied and one is not occupied, the request may be carried out on the computer that is not occupied.

It should be noted that any number of media devices and/or user input devices may be included in any suitable manner in connected platform environment 400. For example, a gaming console different than gaming console 402 may be included in room 2 near television 404. Furthermore, although environment 400 is illustrated as a single household, environment 400 may also include any suitable device outside of the household. For example, environment 400 may include a computer at a location remote to the household illustrated in FIG. 4. In such embodiments, a server or source, such as media guidance data source 318 of FIG. 3, may act as a gateway for connected platform environment communications between different locations. In some embodiments, the server or source may aid users in accessing remote media devices without further configuration on the part of the user. For example, a user may bring a personal user input device, such as a mobile phone, to a friend's house and utilize the user input device to access media content stored on the user's media devices from the friend's media devices without configuration by the users. In some embodiments, the accessed media content may be content in the form of screen sharing as discussed above.

As an illustrative example a first and second user may be located in room 2 of the local household illustrated in FIG. 4. The local household may be the first user's household, while the second user may be associated with a second household, remote to the first household. At some point, the second user may request media content stored on a remote media device to be provided to a local media device, such as television 404. For example, the second user may have a video stored on the second user's home computer (e.g., at the remote location) which the second user wishes to view with the first user at the first user's household (e.g., the local location). For example, the second user may use a personal user input device, such as a mobile phone, to attempt to communicate with the second user's home computer. For example, the second user may point a mobile phone equipped with an IR transceiver at television 404 and input a command to play the remote media content. Once the second user inputs the command, the mobile phone will transmit the second user's request using a suitable communication channel, such as IR, as discussed above.

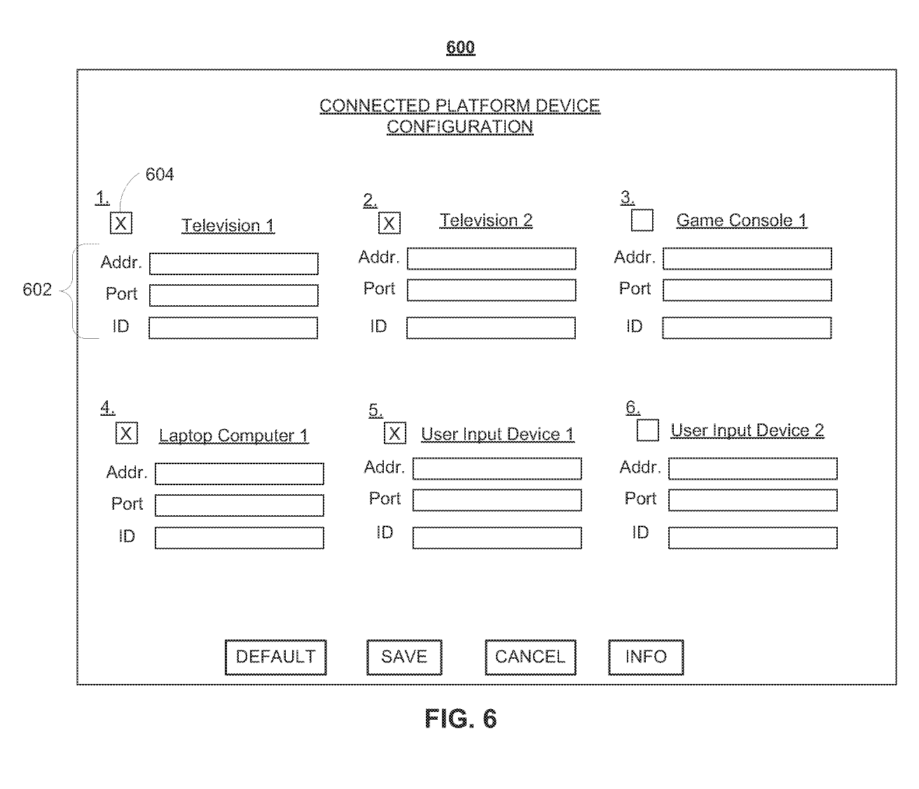

In some embodiments, a local media device may receive the request from the second user's input device, but may be unable to fulfill the request. For example, the request may be formatted in accordance to a communication standard that is utilized in the second user's household connected platform environment, but not in the first user's household connected platform environment. In some embodiments, a local media device may be unable to fulfill the request because it is unaware of the device associated with the request. For example, the request may include a device ID to identify the second user's home computer; however, the device ID of the second user's home computer is not included in the first user's household connected platform environment configuration (such connected platform environment configuration as discussed in greater detail below with regard to FIG. 6). In such an embodiment, the local media device (e.g., television 404) may be incapable of determining what device is associated with the second user's request and/or communicating with the second user's media devices without further information.

In some embodiments, when a media device is incapable of understanding a request or unable to determine what media device is associated with a request, the media device that initially received the request may transmit the request to other media devices in the local connected platform environment (e.g. other known and/or unknown media devices in the household). For example, television 404 may forward the request and/or transmit a query regarding the request to gaming console 402 and computer 406 in the local household.

If no media device and/or user input response is able to positively respond to the query (e.g., fulfill the request themselves or provide information on how to fulfill the request), the media device that initially received the request may transmit the request to a server, for example, media guidance data source 318 of FIG. 3. In some embodiments, the media device that initially received the request may transmit the request to a server without attempting to contact other media devices in the local connected platform environment.

In some embodiments, media guidance data source 318 may be configured to understand requests from multiple households with connected platform environment capabilities. For example, media guidance data source 318 may be able to decipher requests formatted according to different communication standards. In some embodiments, information associated with the media devices and/or user input devices at the multiple households may be stored at media guidance data source 318. For example, the device ID, network information, and/or location information for television 404 and the second user's home computer may be stored at media guidance data source 318. In some embodiments, source 318 may store information that correlates user input devices to particular households and/or media devices. For example, source 318 may be able to determine that a request from the second user's input device is destined for a media device at the second user's household based on the device information of the second user's input device.

Once the media device that initially received the request (e.g., television 404) transmits the request to a server (e.g., media guidance data source 318), the server determines what media device is required to fulfill the request. In example above, the required media device is the second user's home computer. For example, once the second user's home computer is determined to be associated with the request, source 318 may transmit the request to the second user's home computer. In some embodiments, source 318 may modify the request prior to transmitting it to the remote media device. For example, source 318 may add a device ID of television 404 (e.g., the destination media device) to the request and/or convert the format of the request to a suitable communication standard.

When the remote media device (e.g., the second user's home computer) receives the request from the server (e.g., media guidance data source 318), the remote media device may execute the request. For example, the second user's home computer may access the requested media content and provide it to television 404. When the request is associated with a screen sharing request, the remote media device may transmit its display information to the local media device. In some embodiments, the remote media device may transmit the requested media content to the local media device directly, for example, utilizing communications network 314. In some embodiments, the remote media device may transmit the requested media content to the server (e.g., media guidance data source 318) to relay the content to the local media device.

In some embodiments, no local media device may execute or attempt to execute the request from the second user's input device. For example, the local media devices may determine that there is no local media device with the device ID included in the second user's request. Upon making such a determination, one or more of the local media devices may transmit a message to the second user's input device to notify the input device that there are no local media devices that are capable of fulfilling the user's request. In some embodiments, the local media devices may not transmit any message to the second user's input device.

In some embodiments, wherein the second user's input device receives a message that indicates there are no local media devices capable of fulfilling the user's request (e.g., no local media device matches the requested media device), the second user's input device may attempt to contact media guidance data source 318 directly using communications network 314. In some embodiments, the second user's input device may attempt to contact media guidance data source 318 directly when no message is received from local media devices and/or without attempting to contact local media devices. For example, the second user's input device may send a request on an IR channel with the device ID of the remote media device and the information regarding the requested action. After waiting for a local media device to acknowledge the request for a predetermined period of time, the second user's input device may activate its RF transceiver and transmit the request to media guidance data source 318 over communications network 314. In some embodiments, the second user's input device may transmit the request directly to media guidance data source 318 without attempting to contact local media devices.

In some embodiments, the request transmitted to media guidance data source 318 may include information regarding the network that the second user's input device is utilizing, the location of the second user's input device, and/or media devices within the vicinity of the second user's input device. This may allow media guidance data source 318 to determine to which media device the response to the request should be sent. For example, the second user's input device does not receive a response to the request from any local media device; the input device may not be able to determine which local media device should provide the requested content, if any. For example, when the request is transmitted to source 318, source 318 may be able to determine that there is a media device within the vicinity of the second user's input device based on the network's IP address or geographical location of the second user's input device (e.g., using GPS). Source 318 may then correlate location and/or network information associated with the second user's request with location and/or network information of media devices registered with and/or stored at source 318.

Once media guidance data source 318 determines a target local media device on which to provide the requested content, source 318 may transmit the request information to the remote media device (e.g., the second user's input device) so that the remote media device may fulfill the request. For example, the remote media device may provide the requested content directly to a local media device via communications network 314 and/or source 318, as discussed above.

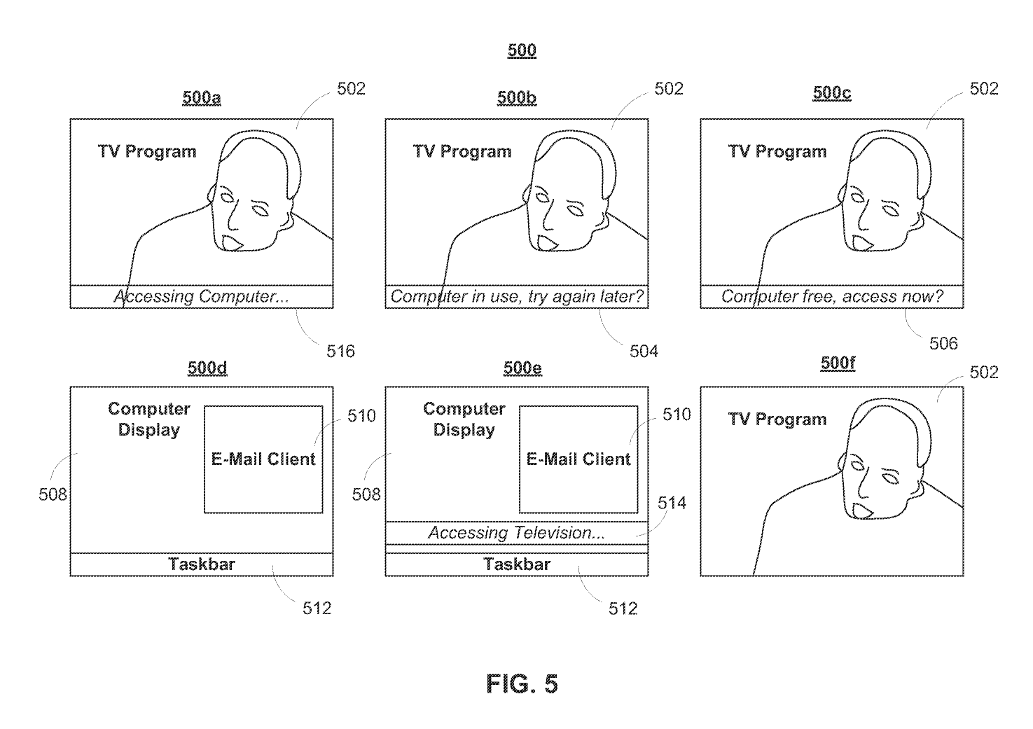

FIG. 5 shows an illustrative screenshots 500 associated with an embodiment wherein a user attempts to switch a media source from a television provider to a computer at a single display. For example, a user may be accessing a television program at a television, such as television 404 of FIG. 4. Thereafter, the user may wish to access an email client who resides on a computer in a different room, such as computer 406 of FIG. 4. The user may input a command using a user input device, such as input device 410 of FIG. 4, to request activation of the email client and screen sharing of the computer.

Screenshot 500a depicts the display of program 502 that may be displayed on, for example, television 404. In some embodiments, message 516 may be displayed at television 404 after the user issues the command requesting screen sharing of computer 406. Message 516 informs the user that an attempt is being made to access computer 406 while the user is viewing program 502.

In some embodiments, a check may be made to determine whether another user is currently accessing computer 406 either locally or remotely. If the check reveals that computer 406 is currently occupied and/or the requesting user does not have the requisite priority, message 504 may be displayed as depicted in screenshot 500b. In some embodiments, the user may request that television 404 and/or the user input device periodically check computer 406 to determine when computer 406 becomes free. In some embodiments, the user may request that computer 406 inform television 404 when it becomes free.

Screenshot 500c depicts message 506 which informs the user that computer 406 is available for access. The users may select to access immediately, in some time in the future, or decline access. In some embodiments, message 506 is not displayed and access is provided to the user as soon as television 404 is aware that computer 406 is available. In all cases, access and sharing may be provided as described above with regard to FIG. 4. For example, television 404 may inform computer 406 that the user wishes to access it. Computer 406 may begin transmission of its display information to television 404. Additionally, television 404 may automatically switch from the program source to the connected platform circuitry, such as connected platform circuitry 110 of FIG. 1 to receive computer 406's display information.

Screenshot 500d depicts shared screen computer display 508 of computer 406 that may be displayed on the display of television 404 after receipt of computer 406's display information via the connected platform circuitry. As noted earlier, the initial request to access computer 406 may have requested the activation of an email client. As such, when the request is received by computer 406, computer 406 may activate email client 510. In some embodiments, the user at television 404 may have complete control of computer 406 using input device 410 of FIG. 4. For example, the user may draft an email on email client 510 which resides on computer 406. As a further example, the user may utilize taskbar 512 to activate another application on computer 406. In some embodiments, computer display 508 may be provided as a partial screen display to allow uninterrupted viewing of program 502. For example, program 502 and display 508 may both be displayed simultaneously on the media device display. In some embodiments, only display information for email client 510 is provided to the media device (e.g., the display information for client 510 is provided without display information for display 508). In such embodiments, display information for client 510 may be overlaid over program 502 so that the user may continue viewing program 502 uninterrupted, but still have access to the desired application.

The user may input the appropriate command when the user is ready to return to the program 502. When the command is received by television 404, television 404 will inform computer 406 that the user no longer wishes to occupy computer 406. In response, computer 406 will cease transmitting its display information to television 404. Additionally, television 404 will switch its source back to the program source from the connected platform circuitry. As the transition back to program 502 begins to occur, or shortly before, television 404 may display message 514 to inform the user the television 404 is about to or is currently switching sources and halting the current screen sharing operation, as shown in screenshot 500e.

In some embodiments, the connected platform circuitry was the previous source. In such embodiments, the connected platform circuitry may resume sharing of the previous media device that was being accessed before the user requested access of computer 406. To achieve this, television 404 may store information relating to what the user was accessing prior to requesting screen sharing. For example, if user was accessing a media asset from a remote device, television 404 may store information associated with the identity of the media asset, the location of the media asset, at what point the user was at in the media asset when the user chose to request screen sharing. For example, the information may indicate the user was seven minutes into a Seinfeld episode when the user requested the last screen sharing operation. The information may additionally indicate that the episode is stored on gaming console 402. When the user requests to cease access from computer 406, television 404 may resume providing of the previous media asset that was being shared by console 402 prior to the screen sharing operation. For example, television 404 may resume access to gaming console 402 and request the Seinfeld episode to be provided from the seven minute mark.

When screen sharing of computer 406 on television 404 is complete, screenshot 500f may be displayed. Screenshot 500f depicts television 404 resuming program 502 from the point, or substantially near the point, at which program 502 was last accessed before the screen sharing operation. In some embodiments, program 502 may be a broadcast program. As such, television 404 may simply return to the last accessed broadcast channel. Alternatively, television 404 may begin recording program 502 when the screen sharing operation is requested. When the screen sharing operation ends, television 404 may provide the recording of the broadcast program it recorded, or a recording of the broadcast program provided by a media provider.

FIG. 6 depicts illustrative connected platform device configuration screen 600 wherein information regarding devices that are included and/or known in a connected platform environment, such as environment 400 of FIG. 4, may be configured by users and/or system operators. In some embodiments, the configurations may be made automatically, for example, by detecting what devices start up on a network in a connected platform environment.

Any suitable identifying information for a device in the connected platform environment may be displayed and/or modified in fields 602. Fields 602 depict a field for the address of television 1, which may be substantially similar to television 404 of FIG. 4. The address of the device may refer to the IP address, MAC address, or any other suitable network address of the device. Fields 602 also show a field for a port identifier. For example, for some devices it would be preferable to have connected platform communications received at and transmitted from a particular port(s) on the respective device. In some embodiments, fields 602 include a field for a device identifier. For example, “television 404” may be a device ID for television 404. Any other suitable ID may be used as the device ID. A user and/or system operator may check box 704 to indicate whether the respective device may be active in the connected platform environment. In FIG. 6, fields 602 only show address, port, and ID fields for illustrative purposes, but in practice may include any number of suitable fields that may aid in connected platform communications.

As discussed above with regard to FIG. 4, the IR and RF communications between the devices of environment 400 may include various identifications. For example, input device 410 may transmit a command which identifies gaming console 402 as the media device that the user intends to remotely control and television 404 as the media device that should display the display information of gaming console 402. Input device 410 may retrieve the necessary identification and communication information from connected platform device configuration screen 700. In some embodiments, some or all of the information provided by screen 600 may be stored locally at each of the devices in the connected platform environment. In some embodiments, some or all of the information in screen 600 may be stored in a server and/or selected devices. In such an embodiment, each of the devices in the environment may communicate with the storage location to retrieve the information necessary to perform the connected platform operations. For example, when a user inputs a request into an input device, the input device may determine that the request is associated with a gaming console. Upon this determination, input device may retrieve the address and port information that is associated with the gaming console from the storage device. The input device may insert the retrieved information into the RF signal so when it is received by a media device, the media device can communicate with the necessary devices to perform the action dictated by the user's request when the retrieved information is received by a media device.

FIG. 7 shows illustrative process 700 for sharing display information at a remote media device and displaying the shared display information at a local media device in accordance with an embodiment. This process may be similar to the process described above with regard to FIGS. 4 and 5. At step 710, a television program is displayed on a first media device. For example, program 502 of FIG. 5 may be displayed on television 404 of FIG. 4. At step 720, a user input is received at a user input device. For example, input device 410 of FIG. 4 may receive a request from a user as described above with regard to FIG. 4.

At step 720, the user input is transmitted to a local media device. For example, input device 410 may transmit the user input information to television 404. In some embodiments, the media device is determined to be local when it is determined to be in the vicinity of the user input device as described above with regard to FIG. 4. The transmission of the user input may be substantially similar to IR signal 416 of FIG. 4. At step 740, the user input is determined to be associated with an application or function on a remote media device as described above with regard to FIGS. 1-6.

Upon determining that the user input is associated with a remote media device, process 700 proceeds to step 750. At step 750, the request is transmitted to a remote media device to request activation of the requested application or function and to instruct the remote media device to provide its display information. For example, the display information may relate only to the display of the requested application.

Alternatively, the display information may relate to the entire remote media device display. A remote media device may refer to any media device that is not in the vicinity of the user input device, for example, any device located in room 1 or room 3 of FIG. 4 when the input device is located in room 2. For example, a request to activate email client 510 of FIG. 5 on computer 406 of FIG. 4 may be sent from television 404 to computer 406. The request may additionally include instructions for computer 406 to provide the display information of computer display 508 to television 404. At step 760, the requested application or function is activated on the remote media device. At step 770, the remote media device begins transmission of its display information to the local media device. The transmission of the display information may be controlled by connected platform circuitry, such as connected platform circuitry 110 of FIG. 1, as described above with regard to FIG. 4.

At step 780, the display information from the remote media device is received and displayed on the local media device. For example, computer display 508 of FIG. 5 from computer 406 of FIG. 4 may be displayed on television 404 of FIG. 2. In some embodiments, at this point, the user may control computer 406 in a normal manner using the user's input device. For example, normal computer commands may be inputted into input device 410. Input device 410 may then transmit the normal commands directly to computer 406 or may transmit the normal commands to television 404, which in turn can relay the commands to computer 406. In some embodiments, the transmission of the display information may be continuous so that the user is provided with an up-to-date replica of the entirety or portion of the remote media device's display on the local media device.

In practice, one or more stages shown in process 700 may be combined with other stages, performed in any suitable order, performed in parallel (e.g., simultaneously or substantially simultaneously), or removed. For example, the determination that the user's input is associated with a remote media device at step 740 may occur before the transmission of the user input to the local media device at step 730. Process 800 may be implemented using any suitable combination of hardware and/or software in any suitable fashion.

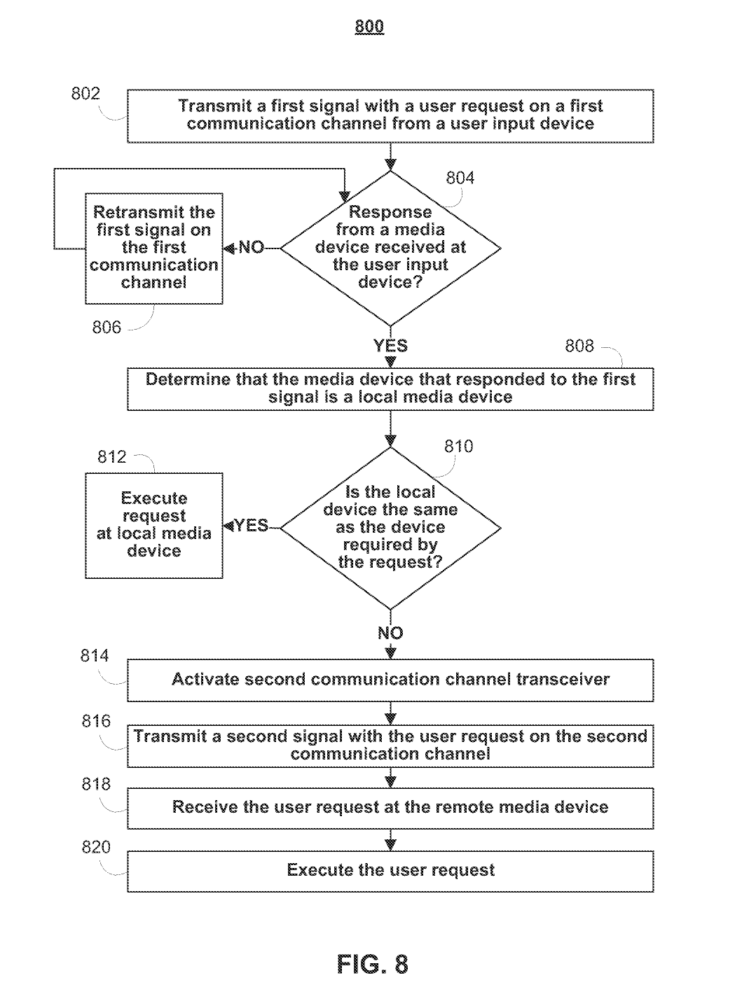

FIG. 8 shows illustrative process 800 for determining whether a user input device is within the vicinity of a media device in a connected platform environment using two communication channels in accordance with an embodiment. This process may be similar to the process described above with regard to FIG. 4. At step 802, a signal with a user request is transmitted from a user input device. For example, IR signal 416 of FIG. 4 may be transmitted from input device 410 using an IR transceiver, such as IR transceiver 210 of FIG. 2. The user request may be request as described above with regard to FIG. 4. For example, the request may be a request for computer 406 of FIG. 4 to activate an email client.

At step 804, the user input device determines whether a response from a media device is received. For example, the user input device may wait for a period of time for an acknowledgement message from a media device. If no message is received, process 800 proceeds to step 806 where the first signal is retransmitted. In some embodiments, the signal may be retransmitted a predetermined number of times, after which the user input device may determine that it is not within the vicinity of any media device. As described above with regard to FIG. 4, the input device may provide some indication to the user that the input device is not within range of a media device. In some embodiments, a media device and/or user input device may periodically transmit a beacon message that the devices use to determine the presence of other devices. In response to a detected beacon, a media device and/or user input device may initiate a connection process.

If a response is received from a media device at the user input device, process 800 proceeds to step 808. For example, upon receiving IR signal 416 from input device 410 of FIG. 4, television 404 may respond with a transmission of IR signal 418 to input device 410. IR signal 418 may be considered the response. At step 808, the user input device determines that the media device is a local media device (e.g., in the general vicinity of the input device). For example, because IR signals may need line-of-sight to complete transmission, it may be assumed that any device capable of receiving an responding to an IR transmission is within the general vicinity of IR transmitting device. As such, all commands issued by the input device may include instructions to display requested functions and/or application on the local display.

At step 810, the user input device determines whether the newly determined local media device is the same device as required by the request transmitted at step 802. For example, the request may require computer 406 to perform some action. The input device may compare the newly determined local media device, which may be for example television 404, to the required media device (e.g., computer 406).

If the requested device and local media device are the same device, process 800 proceeds to step 812. At step 812, the request is executed at the local media device. For example, if the local media device is determined to be computer 406 and the request is requesting activation of an email client on computer 406, computer 406 may activate the email client and display it on its local display without any further communications (e.g., without involvement of other devices in the connected platform environment).

Process 800 proceeds to step 814 when it is determined that the local media device is different from the remote media device at step 810. At step 814, a second communication channel transceiver is activated. For example, if the request is for a remote device, input device 410 may activate an RF transceiver, such as RF transceiver 208 of FIG. 2. In some embodiments, a second communication channel transceiver is activated at the local media device. After the activation of the second channel transceiver, process 800 proceeds to step 816. At step 816, a second signal is transmitted from the user input device on the second communication channel, wherein the second signal includes the user request. For example, RF signal 420 of FIG. 4 may be transmit from user input device 410. In some embodiments, the RF signal may also include information media device identification as described with regard to FIGS. 4-8. For example, RF signal 420 may include information identifying computer 406 as the remote media device for which an action is being requested. Determining that computer 406 is the correct remote media device may be determined based on configuration information as discussed above with regard to FIG. 6. Additionally, or alternatively, RF signal 420 may include information identifying television 404 as the local media device that should be used to display information provided by the remote media device. Television 404 and computer 406 may be determined to be a local media device and a remote media device, respectively, based on steps 804, 808, and 810. After transmitting the second signal, process 800 proceeds to step 818.

At step 818, the user request is received at the remote media device. In some embodiments, the information is received directly from the second signal transmitted at step 816. For example, computer 406 may receive RF signal 420 directly from the input device transmission. In some embodiments, the second signal (e.g., RF signal 420) is received by the local media device and relayed to the remote media device over communications network 314 of FIG. 3. For example, computer 406 may be too far to receive the transmitted RF signal from the user input device. As such, television 404 may relay the information contained in the RF signal to computer 406 using any suitable communications means.

Once the user request is received at the remote device, process 800 proceeds to step 820. At step 820, the user request is executed. For example, the remote device activates an email client and transmits its display information to the local device using connected platform circuitry as described above with regard to process 700 of FIG. 7.

In practice, one or more stages shown in process 800 may be combined with other stages, performed in any suitable order, performed in parallel (e.g., simultaneously or substantially simultaneously), or removed. For example, the act of determining a media device to be a local device at step 808 and determining whether the requested device is the same as the local device at step 810 may computed at substantially the same time. Process 800 may be implemented using any suitable combination of hardware and/or software in any suitable fashion.

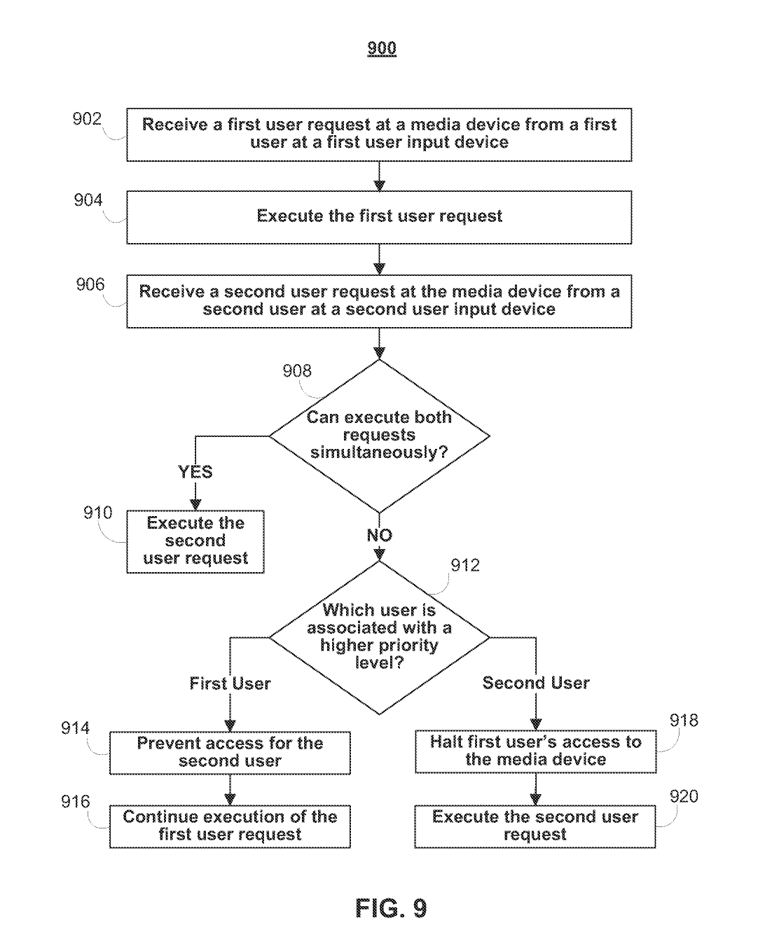

FIG. 9 shows illustrative process 900 for preventing a user from accessing a remote media device that is already occupied by another user in a connected platform environment in accordance with an embodiment. This process may be similar to the process described above with regard to user priority levels in FIG. 4. For example, a user at one media device may request another media device to perform some activity; however, another user may already be using the other media device when the request is issued.

At step 902, a first user request is received at a media device from a first user at a first user input device. For example, the first user request may command the media device to share its display with another media device in the connected platform environment. At step 1004, the media device executes the request. For example, the request may be executed as discussed above with regard to process 700 of FIG. 7. In some embodiments, the media device may determine itself to be occupied when the media device begins to execute the first user request as discussed above with regard to FIG. 4.

At step 906, a second user request is received at the media device from a second user at a second user input device. For example, the second user request may be another command that requests activation of some application on the media device and share its display with another media device. The second user request may be any suitable connected platform environment user input.

At step 908, the media device may determine whether it is possible to execute both requests simultaneously once the second request is received from the second input device. For example, the media device may be able to execute both simultaneously if the second request is requesting an application that is different from an application utilized by the first user. As a further example, the media device may be able to execute both simultaneously if at least one user is only accessing the storage of the media device and did not request complete control over the media device. For example, the first user may have requested a media asset that is stored in the media device to be transmitted to another media device. Such an action does not necessarily completely occupy the media device. If so, the second user may still be able to gain access to the media device without regard to the users' priority levels when the second user wants control over the media device (e.g., complete control over the user interface of the media device). If it is determined that both requests may be executed simultaneously, process 900 proceeds to step 910 where the second user request is executed.

Process 900 proceeds to step 912 if it is determined that both requests cannot be executed simultaneously. At step 912, it is determined which user is associated with a higher priority level. The priority levels assigned to each user are discussed above with regard to FIG. 4. For example, the first user accessed the media device first, and therefore may be assigned a higher priority than the second user who issued the request after the first user. If the first user is associated with a higher priority level than the second user, process 900 proceeds to step 914.

At step 914, access to the media device is prevented for the second user. In some embodiments, message 504 of FIG. 5 may be displayed to the second user upon being denied access to the media device. After preventing access for the second user, process 900 may proceed to step 916, where the execution of the first request is continued. In some embodiments, execution of the first request is not halted or modified when process 900 is at step 914. In some embodiments, the first user may be presented with a notification that the second user is attempting to gain access to the media device. In some embodiments, the first user may be presented with an option to relinquish control of the media device to allow the second user to gain control of the media device, despite the users' associated priority levels.

If the first user is associated with a lower priority level than the second user, process 900 proceeds to step 918. At step 918, the first user's access is halted at the media device. In some embodiments, a message may be displayed to the first user that the second user is taking control of the media device. In some embodiments, the first user may request a notification when the second user relinquishes control of the media device. In some embodiments, the first user may regain control of the media device automatically as the second user relinquishes control of the media device. After halting the first user's access to the media device at step 918, process 900 proceeds to step 920. At step 920, the second user request is executed at the media device as discussed above.

In practice, one or more stages shown in process 900 may be combined with other stages, performed in any suitable order, performed in parallel (e.g., simultaneously or substantially simultaneously), or removed. For example, executing the first user request at step 904 and receiving the second user request at step 906 may occur substantially simultaneously. Process 900 may be implemented using any suitable combination of hardware and/or software in any suitable fashion.

The above described embodiments of the present invention are presented for purposes of illustration and not of limitation, and the present invention is limited only by the claims which follow.

1. A method for providing users access to media devices based on priority levels of the users in a connected platform environment, the method comprising:
receiving a first user request at a first media device from a first user input device, wherein the first user request includes a request for the first media device to share its screen with a second media device;
executing the first user request by sharing the screen of the first media device with the second media device;
receiving a second user request at the first media device from a second user input device, after receiving the first user request, wherein the second user request includes a request for the first media device to share its screen with a third media device;
determining whether the first media device can execute both user requests simultaneously;
determining which user request of the first and second user requests is associated with a higher priority level if the first media device cannot execute both user requests simultaneously; and
executing the user request associated with the higher priority level upon determination of which user request is associated with the higher priority level.

2. The method of claim 1, further comprising providing a message to a user at the second user input device that the first media device is occupied when the second user input device is associated with a lower priority level than the first user input device.

3. The method of claim 1, further comprising continuing the execution of the first user request when the first user input device is associated with the higher priority level.

4. The method of claim 1, further comprising providing a user at a user input device associated with a lower priority level an option to monitor the first media device to determine when the first media device becomes unoccupied.

5. The method of claim 1, further comprising halting the execution of the first user request when the first user input device is associated with a lower priority level than the second user input device.

6. The method of claim 5, further comprising providing a user at the first user input device with an option to monitor the first media device to determine when a user at the second user input device ceases to occupy the first media device.

7. The method of claim 1, further comprising executing the second user request while simultaneously executing the first user request when it is determined that the first media device can execute the requests simultaneously.

8. The method of claim 1, wherein the first and second user input devices are at least one of a keyboard, a television remote, a set-top box remote, or a gaming controller.

9. The method of claim 1, wherein the first, second, and third media devices are at least one of a television, a computer, a wireless device, or a gaming console.

10. A system for providing users access to media devices based on priority levels of the users in a connected platform environment, the system comprising:
a first media device comprising:
a receiver configured to:
receive a first user request from a first user input device, wherein the first user request includes a request for the first media device to share its screen with a second media device, and
receive a second user request at the first media device from a second user input device, after receiving the first user request, wherein the second user request includes a request for the first media device to share its screen with a third media device; and
processing circuitry configured to:
execute the first user request by sharing the screen of the first media device with the second media device,
determine whether the first media device can execute both user requests simultaneously,
determine which user request of the first and second user requests is associated with a higher priority level if the first media device cannot execute both user requests simultaneously, and
execute the user request associated with the higher priority level upon determination of which user request is associated with the higher priority level.

11. The system of claim 10, wherein the processing circuitry is further configured to provide a message to the second user input device indicating that the first media device is occupied when the second user input device is associated with a lower priority level than the first user input device.

12. The system of claim 10, wherein the processing circuitry is further configured to continue the execution of the first user request when the first user input device is associated with the higher priority level.

13. The system of claim 10, wherein the processing circuitry is further configured to provide a user at a user input device associated with a lower priority level an option to monitor the first media device to determine when the first media device becomes unoccupied.

14. The system of claim 10, wherein the processing circuitry is further configured to halt the execution of the first user request when the first user input device is associated with a lower priority level than the second user input device.

15. The system of claim 14, wherein the processing circuitry is further configured to provide the first user input device with an option to monitor the first media device to determine when a user at the second user input device ceases to occupy the first media device.

16. The system of claim 10, wherein the processing circuitry is further configured to execute the second user request while simultaneously executing the first user request when it is determined that the first media device can execute the requests simultaneously.

17. The system of claim 10, wherein the first and second user input devices are at least one of a keyboard, a television remote, a set-top box remote, or a gaming controller.

18. The system of claim 10, wherein the first, second, and third media devices are at least one of a television, a computer, a wireless device, or a gaming console.

19-27. (canceled)
